(19) United States
(12) Patent Application Publication
(10) Pub. No.: US 2020/0025857 A1
(43) Pub. Date: Jan. 23, 2020

(54) SYSTEM FOR DETECTING SOUND GENERATION POSITION AND METHOD FOR DETECTING SOUND GENERATION POSITION

(71) Applicant: Panasonic Intellectual Property Management Co., Ltd., Osaka (JP)

(72) Inventors: Taishi ASANO, Osaka (JP); Shunsuke SAITO, Osaka (JP); Naofumi KITANO, Osaka (JP); Kenji TACHIBANA, Osaka (JP)

(21) Appl. No.: 16/586,018

(22) Filed: Sep. 27, 2019

Related U.S. Application Data
(63) Continuation of application No. PCT/JP2018/009616, filed on Mar. 13, 2018.

(30) Foreign Application Priority Data
Mar. 30, 2017 (JP) 2017-067637

(51) Int. Cl. G01S 3/802; H04R 1/32; G10L 15/20; G10L 17/26

(52) U.S. Cl. CPC G01S 3/802; G10L 17/26; G10L 15/20; H04R 1/326

(57) ABSTRACT

A system for detecting a sound generation position includes three or more first sound acquisition units and a position detector. The three or more first sound acquisition units acquire a sound of a sound event generated around a first mobile object, and are disposed in positions spaced apart from each other in the mobile object, respectively. The position detector detects a direction or a position where the sound event occurs, based on the difference between acquisition times at which the sound is acquired at the three or more first sound acquisition units.

### BACKGROUND

### 1. Technical Field

The present disclosure relates to a system for detecting a sound generation position and a method for detecting a sound generation position.

### 2. Description of the Related Art

In recent years, when acoustic events such as explosion or blasting occur, an apparatus and a method for detecting a position and a direction where a sound is generated is used.

For example, Patent Literature 1 (PTL 1) discloses a blasting position system that calculates a blasting position as a candidate based on arrival angle information and arrival time information provided by an acoustic sensor including four or more microphones having rotational symmetry.

Here, PTL 1 is Unexamined US Patent Publication No. 2010/0118658

### SUMMARY

However, the above-described blasting position detection method using the blasting position system has the following issue.

That is, in the method disclosed in the above PTL 1, a blasting position is specified by using the acoustic sensor including four or more modularized microphones, and thus distances between the microphones disposed in the acoustic sensor are about dozen centimeters, namely, short.

Thus, it is difficult to accurately detect the blasting position because a difference in times at which blasting sounds generated at the microphones is small.

The present disclosure provides a system for detecting a sound generation position and a method for detecting a sound generation position that can accurately detect a position where a sound event such as a blasting sound occurs.

A system for detecting a sound generation position according to one aspect of the present disclosure includes three or more first sound acquisition units and a position detector. The three or more first sound acquisition units acquire a sound of a sound event generated around a first mobile object, and are disposed in positions spaced apart from each other in the mobile object, respectively. The position detector detects a direction or a position where the sound event occurs, based on the difference between acquisition times at which the sound is acquired at the three or more first sound acquisition units.

The system for detecting a sound generation position according to one aspect of the present disclosure can detect a sound generation position accurately.

### BRIEF DESCRIPTION OF DRAWINGS

FIG. 1 is a schematic diagram illustrating a configuration of a system for detecting a sound generation position according to one exemplary embodiment of the present disclosure.

FIG. 2 is a conceptual diagram illustrating a method for detecting a sound generating direction based on any one of sound acquisition times at which a sound is acquired by a plurality of microphones included in the system for detecting a sound generation position in FIG. 1.

FIG. 3 is a plan view illustrating a state where a plurality of microphones configuring the system for detecting a sound generation position in FIG. 1 is attached to a vehicle.

FIG. 4 is a conceptual diagram illustrating a method for detecting a blasting direction using sound information acquired at the plurality of microphones mounted to a plurality of vehicles.

FIG. 5A is a graph illustrating a relationship between a time difference and an angle (θ) where a sound is acquired by the plurality of microphones in FIG. 4.

FIG. 5B is a graph illustrating a relationship between the time difference and the angle (θ) where the sound is acquired by the plurality of microphones in FIG. 4.

FIG. 5C is a graph illustrating a relationship between the time difference and the angle (θ) where the sound is acquired by the plurality of microphones in FIG. 4.

FIG. 6 is a graph illustrating a result of comparing the configuration of the present disclosure and a comparative example.

FIG. 7 is a control block diagram illustrating a configuration of a vehicle mounted with the plurality of microphones configuring the system for detecting a sound generation position in FIG. 1.

FIG. 8 is a control block diagram of a command center which receives information about a sound generation position from the vehicle in FIG. 7.

FIG. 9 is a flowchart illustrating processing of the method for detecting a sound generation position in a vehicle included in the system for detecting a sound generation position in FIG. 1.

FIG. 10 is a flowchart illustrating processing of the method for detecting a sound generation position in the command center included in the system for detecting a sound generation position in FIG. 1.

FIG. 11 is a schematic diagram illustrating a system configuration including vehicles each mounted with a plurality of microphones configuring the system for detecting a sound generation position and a plurality of microphones mounted to buildings according to another exemplary embodiment of the present disclosure.

FIG. 12 is a control block diagram illustrating a configuration of a vehicle of the system for detecting a sound generation position according to still another exemplary embodiment of the present disclosure.

FIG. 13 is a perspective view illustrating a vehicle in which a plurality of microphones, which configures the system for detecting a sound generation position according to still another exemplary embodiment of the present disclosure, is three-dimensionally disposed.

### DESCRIPTION OF EMBODIMENT

Hereinafter, an exemplary embodiment will be described in detail with reference to the drawings as appropriate. However, detailed description more than necessary may be sometimes omitted. For example, there are cases where redundant explanations with respect to detailed descriptions of well-known matters and substantially the same configuration are omitted. This is to avoid the following description from being unnecessarily redundant, and to facilitate understanding of those skilled in the art.

Note that the applicants provides the accompanying drawings and the following description in order to allow those skilled in the art to fully understand the present disclosure, and do not intend to limit the subject matter as described in the appended claims.

### First Exemplary Embodiment

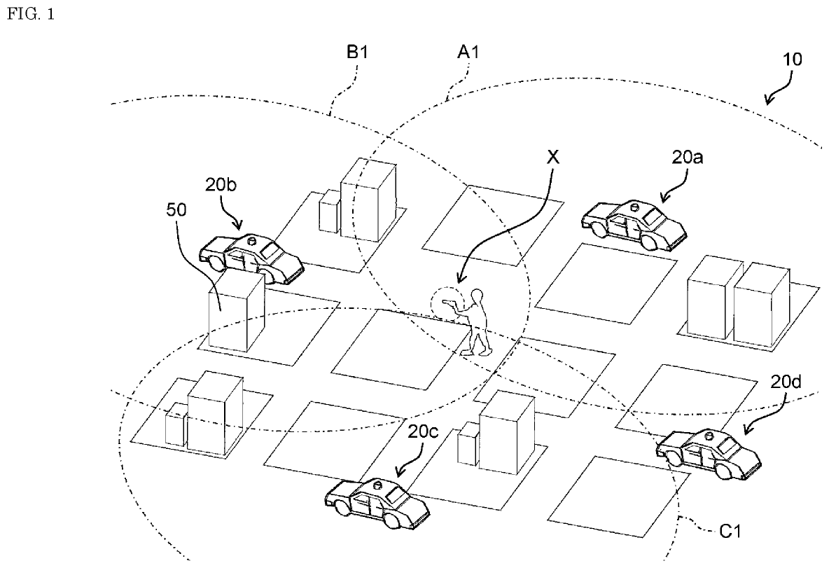

System for detecting a sound generation position 10 according to one exemplary embodiment of the present disclosure will be described as follows with reference to FIGS. 1 to 10.

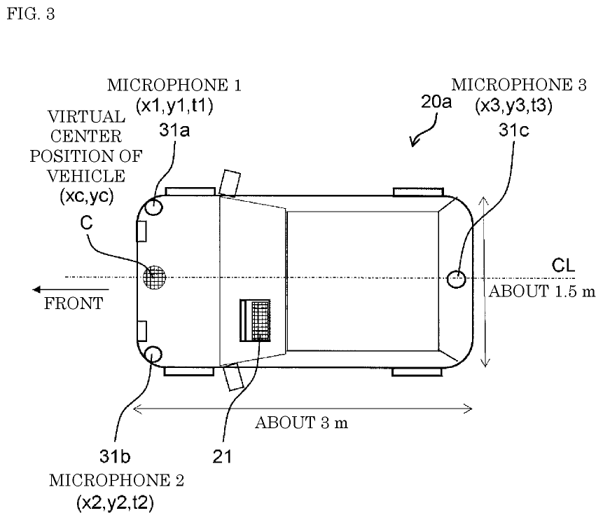

System for detecting a sound generation position 10 according to the present exemplary embodiment, as illustrated in FIG. 1, detects blasting position (sound event generating position) X using a plurality of microphones (sound acquisition units, first sound acquisition units) 31a to 31c (see FIG. 3, etc.) mounted to a plurality of vehicles 20a to 20d, respectively. Vehicles 20a to 20d are, for example, police vehicles.

System for detecting a sound generation position 10 includes, as illustrated in FIG. 1, vehicles 20a to 20d, and command center 50 that carries out a communication with vehicles 20a to 20d.

In an example of FIG. 1, when a blasting event (a sound event) occurs in blasting position X, vehicle (mobile object, first mobile object) 20a is in a position where a blasting sound enters from blasting position X through a side of vehicle 20a. Vehicle 20a is mounted with three microphones 31a to 31c (see FIG. 3). Microphones 31a to 31c each acquire a sound within a range of area A1 around vehicle 20a.

In the example of FIG. 1, when a blasting event (a sound event) occurs in blasting position X, vehicle (mobile object, second mobile object) 20b is in a position where a blasting sound enters from blasting position X through a rear of vehicle 20b. Vehicle 20b includes three microphones. The three microphones each acquire a sound within a range of area B1 around vehicle 20b.

In the example of FIG. 1, when a blasting event (a sound event) occurs in blasting position X, vehicle (mobile object, second mobile object) 20c is in a position where a blasting sound enters from blasting position X through a side of vehicle 20c. Vehicle 20c includes three microphones. The three microphones each acquire a sound within a range of area C1 around vehicle 20c.

Herein, a principle of detecting a direction or a position of blasting position X by using microphones 31a to 31c mounted to vehicle 20a will be described.

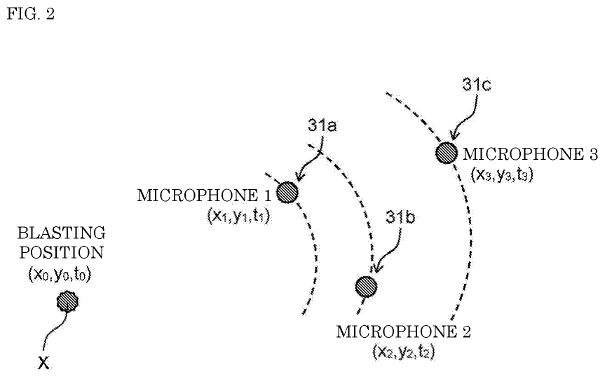

As illustrated in FIG. 2, microphones 31a to 31c are spaced apart from each other. Times at which position coordinates and blasting sounds of microphones 31a to 31c are defined as microphone 1 (x₁, y₁, t₁), microphone 2 (x₂, y₂, t₂), and microphone 3 (x₃, y₃, t₃). Position coordinates of blasting position X and a time at which a blasting sound is generated are defined as (x₀, y₀, t₀). A relationship between microphones 31a to 31c and blasting position X is expressed by the following Equation.

υ(t₁−t₀)=\sqrt{(x₁−x₀)²+(y₁−y₀)²}

υ(t₂−t₀)=\sqrt{(x₂−x₀)²+(y₂−y₀)²}

υ(t₃−t₀)=\sqrt{(x₁−x₀)²+(y₃−y₀)²} [Equation 1]

wherein, v is a sonic speed.

Values of known v (sonic speed≈about 350 m/s), microphone 1 (x₁,y₁,t₁), microphone 2 (x₂,y₂,t₂), and microphone 3 (x₃,y₃,t₃) are assigned into these three equations, and thus blasting position X and blasting time (x₀,y₀,t₀) can be obtained.

That is, microphones 31a to 31c are mounted to vehicle 20a, and thus vehicle 20a can acquire the blasting sound generated near vehicle 20a. Vehicle 20a can further detect a direction or a position of blasting position X based on a difference between times (time difference) at which the blasting sound is acquired by microphones 31a to 31c.

Vehicle 20a has, as illustrated in FIG. 3, a vehicle body of about 3 m long by about 1.5 m wide. Microphones 31a, 31b are mounted to two places (a hood, etc.) at both ends in a widthwise direction on a front portion of the vehicle body. Microphone 31c is mounted to one place (a rear portion of the vehicle body) at the center of a rear portion of the vehicle body. That is, in the present exemplary embodiment, microphones 31a to 31c are disposed in the vehicle body of vehicle 20a of about 3 m long by about 1.5 m wide so that distances between the microphones 31a to 31c are as long as possible.

Thus, microphones 31a, 31b and microphone 31c are disposed in positions spaced about 3 m apart from each other. Microphone 31a and microphone 31b are disposed in positions spaced about 1.5 m apart from each other.

Further, vehicle 20a is, as illustrated in FIG. 3, mounted with vehicle-borne personal computer (PC) 21.

Vehicle-borne PC 21 has functions as communication unit 39 and display unit 40, described later.

Note that other vehicles 20b to 20d illustrated in FIG. 1 are mounted with a plurality of microphone and vehicle-borne PC 21 in similar positions.

Herein, blasting position X and blasting time establish a relationship: (x₀, y₀, t₀)=(0,0,0). As illustrated in FIG. 3, virtual center C of vehicle 20a is a point (xₑ, y_{c}) at which a line which connects microphone 31a and microphone 31b mounted to two places on the front portion of vehicle 20a intersects center line CL of vehicle 20a.

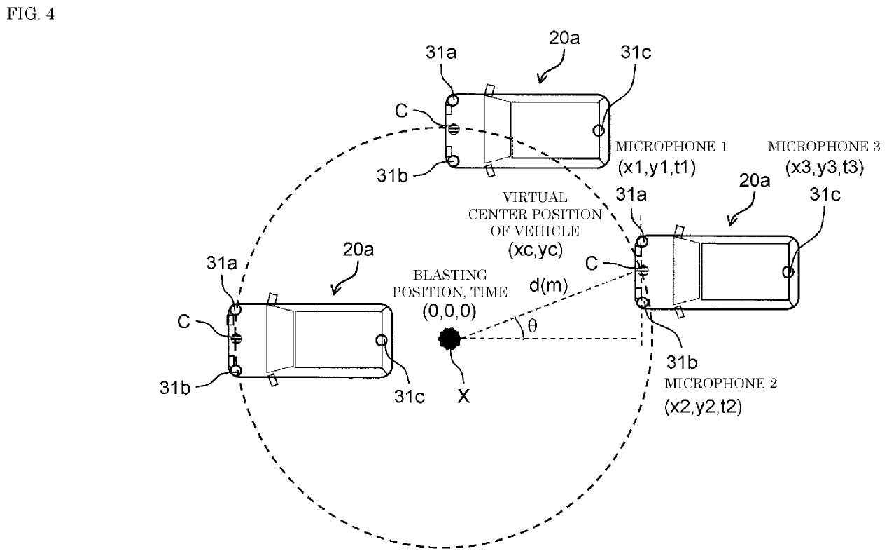

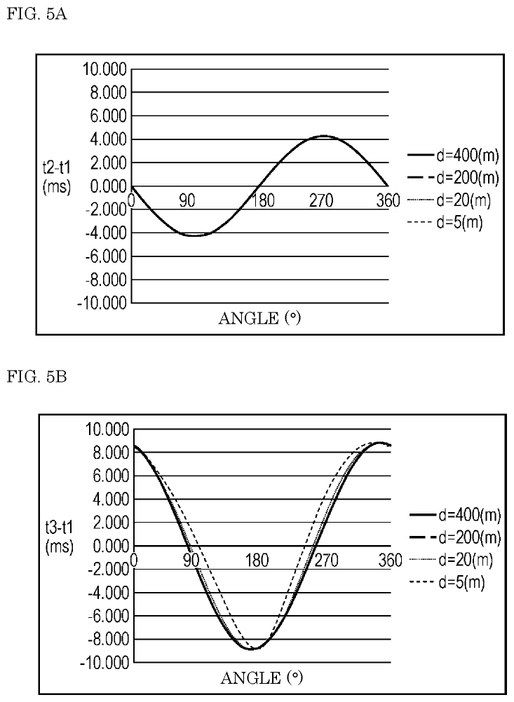

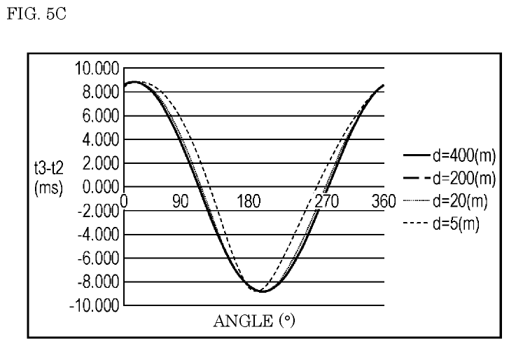

As illustrated in FIG. 4, a change in a difference between acquisition times (a time difference) at which a blasting sound is acquired by microphones 31a to 31c in a case where virtual center C (x_{c}, y_{c}) of vehicle 20a rotates about blasting position X and blasting time (x₀,y₀,t₀) by 360° was verified. In a case where an angle (in FIG. 4, angle θ of a virtual center position) of microphones 31a to 31c with respect to blasting position X is changed, the difference between the acquisition times (the time difference) at which the blasting sound is acquired by microphones 31a to 31c changes as illustrated in graphs of FIG. 5A, FIG. 5B, and FIG. 5C.

Note that the graphs of FIG. 5A, FIG. 5B, and FIG. 5C indicate results of verifying a case where a distance d(m) from blasting position X to virtual center C of vehicle 20a is 5 m, 20 m, 200 m, and 400 m.

FIG. 5A illustrates a relationship between a time difference (t2−t1) which is a difference between the acquisition times at which the blasting sound is acquired by microphones 31a, 31b and the angle θ.

When the angles θ of microphones 31a, 31b disposed in the two places on the front portion of the vehicle body are about 90° and about 270° as illustrated in FIG. 4, namely, the vehicle body is horizontally oriented with respect to blasting position X, a difference in the distance from blasting position X becomes largest. On the contrary, when the angles θ are about 0° (about 360°) and about 180°, namely, the vehicle body is vertically oriented with respect to blasting position X, the difference in the distance from blasting position X becomes smallest.

Therefore, as illustrated in a sine wave graph of FIG. 5A, the time difference (t2−t1) becomes smallest at the anglesθ of about 90°, becomes largest at the angles θ of about 270°, and becomes 0 at the angles θ of about 0° and about 180°.

Note that in FIG. 5A, even when the distance d(m) from blasting position X to the virtual center C of vehicle 20a changes to 5 m, 20 m, 200 m, and 400 m, the graph is approximately identical. That is, even if the distance between blasting position X and vehicle 20a changes, the relationship between the angles θ and the time difference (t2−t1) does not change.

As illustrated in FIG. 4, when the angles θ of microphone 31a on the front portion of the vehicle body and microphone 31c on the rear portion of the vehicle body are about 0° (about 360°) and about 180°, namely, the vehicle body is vertically oriented with respect to blasting position X, the difference in the distance from blasting position X to becomes largest. On the contrary, when the angles θ are about 90° and about 270°, namely, the vehicle body is horizontally oriented with respect to blasting position X, the difference in the distances from blasting position X becomes smallest.

Thus, as illustrated in a sine wave graph of FIG. 5B, a time difference (t3−t1) becomes largest at the angles θ of about 0° (about 360°), becomes smallest at the angles θ of about 180°, and becomes 0 at the anglesθ of about 90° and about 270°.

Note that in comparison with the graph of FIG. 5A, a maximum value and a minimum value of the time difference are large because the distance between microphones 31a, 31c is longer than the distance between microphones 31a, 31b.

Further, in the graph of FIG. 5B, when the distance d(m) from blasting position X to virtual center C of vehicle 20a is 5 m, the graph is approximately identical even if the distance changes to 20 m, 200 m, and 400 m although a slight deviation is present. That is, even if the distance between blasting position X and vehicle 20a changes, the relationship between the angles θ and the time difference (t3−t1) hardly changes.

As illustrated in FIG. 4, when the angles θ of microphone 31b on the front portion of the vehicle body and microphone 31c on the rear portion of the vehicle body are about 0° (about 360°) and about 180°, namely, the vehicle body is vertically oriented with respect to blasting position X, the difference in the distance from blasting position X becomes largest. On the contrary, when the angles θ are about 90° and about 270°, namely, the vehicle body is horizontally oriented with respect to blasting position X, the difference in the distance from blasting position X becomes smallest.

Thus, as illustrated in a sine wave graph of FIG. 5C, a time difference (t3−t2) becomes largest at the angles θ of about 0° (about 360°), becomes smallest at the angles θ of about 180°, and becomes 0 at the angles θ of about 90° and about 270°.

Note that in comparison with the graph of FIG. 5A, a maximum value and a minimum value of the time difference are large because the distance between microphones 31b, 31c is longer than the distance between microphones 31a, 31b.

Further, in the graph of FIG. 5C, when the distance d(m) from blasting position X to virtual center C of vehicle 20a is 5 m, the graph is approximately identical even if the distance changes to 20 m, 200 m, and 400 m although a slight deviation is present. That is, even if the distance between blasting position X and vehicle 20a changes, the relationship between the angles θ and the time difference (t3−t2) hardly changes.

Accordingly, a difference between the acquisition times (a time difference) at which a blasting sound is acquired by microphones 31a to 31c mounted to vehicle 20a is obtained, and thus a direction or a position of blasting position X as viewed from vehicle 20a can be specified.

In system for detecting a sound generation position 10 according to the present exemplary embodiment, as illustrated in FIG. 3, microphones 31a to 31c are disposed in the vehicle body of several meters square so that the distances between microphones 31a to 31c are as large as possible.

Specifically, microphones 31a to 31c mounted to one vehicle 20a are disposed in two places at both ends in the widthwise direction on the front portion of the vehicle body of vehicle 20a and in one place at the center of the rear portion of the vehicle body.

Accordingly, microphones 31a to 31c are disposed in positions spaced several meters apart from each other, and thus the difference between the acquisition times at which the blasting sound is acquired by microphones 31a to 31c can be made to be large.

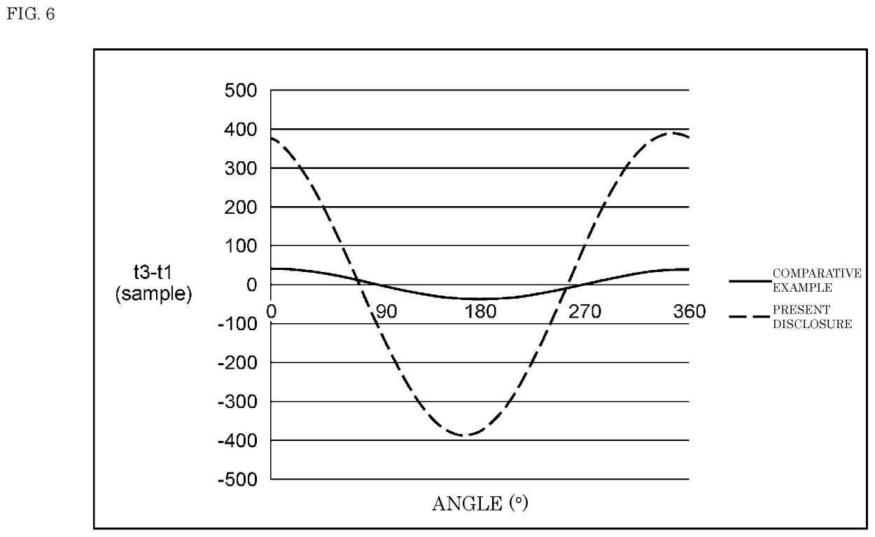

As a result, as illustrated in FIG. 6, in comparison with a comparative example (a solid line) in which the direction of blasting position X is specified by using a plurality of microphones disposed in positions spaced several centimeters to 30 centimeters apart from each other, the difference between the times at which the blasting sound is acquired by microphones 31a to 31c is set to be larger, and thus resolution can be improved.

Note that in the comparative example illustrated in FIG. 6, maximum and minimum peak values in the graph are about ±40. Therefore, this system (a dotted line), in which the maximum and minimum peak values are ±400, has resolution which is about 10 times as high as resolution of the comparative example (the solid line).

### Configuration of System for Detecting a Sound Generation Position 10

### Vehicle 20a

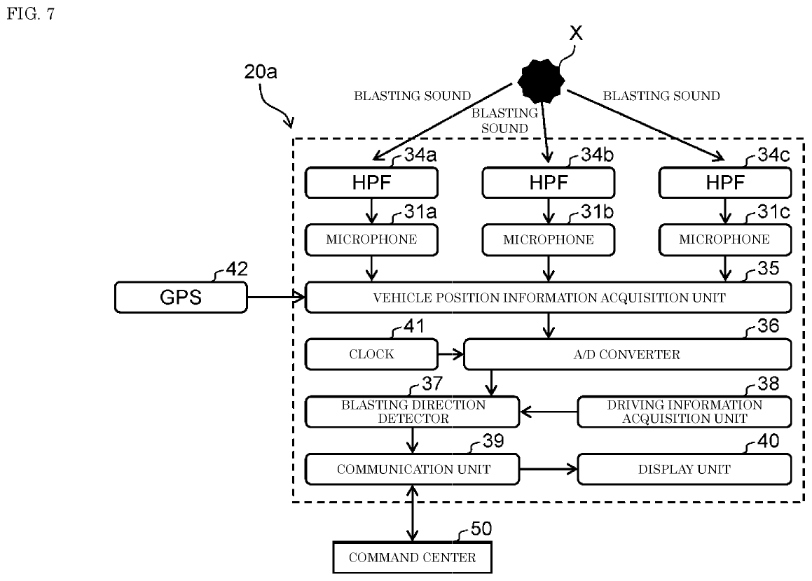

In system for detecting a sound generation position 10 according to the present exemplary embodiment, vehicle 20a has a configuration illustrated in FIG. 7.

Note that the configuration of vehicle 20a is described herein, and other vehicles 20b, 20c have the similar configuration.

Specifically, as illustrated in FIG. 7, vehicle 20a includes microphones 31a to 31c, high pass filters (HPFs) 34a to 34c, vehicle position information acquisition unit 35, analog/digital (A/D) converter 36, blasting direction detector 37, driving information acquisition unit 38, communication unit 39, display unit 40, and clock 41.

Microphones 31a to 31c are, as described above, disposed in vehicle 20a so as to acquire a sound (a blasting sound) generated by a sound event such as blasting. Specifically, microphones 31a, 31b are disposed in two places at both ends in the widthwise direction on the front portion of the vehicle body. Microphone 31c is disposed in one place at the center of the rear portion of the vehicle body. In the present exemplary embodiment, microphones 31a to 31c are mounted to vehicle 20a so that the distances between microphones 31a to 31c are as large as possible.

HPFs (filter portions) 34a to 34c are, as illustrated in FIG. 7, associated with microphones 31a to 31c, and are disposed on an upstream side (blasting position X side) of microphones 31a to 31c. HPFs 34a to 34c remove components of less than or equal to predetermined frequency (for example, less than or equal to 2 kHz) from sound signals (a sound waves) directing to microphones 31a to 31c.

Thus, before the sound signals arrive at microphones 31a to 31c, the components in a frequency band of less than or equal to predetermined frequency can be removed from the sound signals. The predetermined frequency is determined so as to be lower than a frequency band of the blasting sound. Therefore, noises are effectively removed from the sound signals, and detection accuracy for the blasting sound can be improved. Further, HPFs 34a to 34c may remove components in a frequency band of a voice from the sound signals directing to microphones 31a to 31c. Thus, privacy of citizens around vehicles 20a to 20c can be secured.

Note that a determination whether a sound acquired by microphones 31a to 31c is a blasting sound as a detection target is made by a determination whether a frequency band of the sound signals from which low-frequency components are removed by HPFs 34a to 34c corresponds to the predetermined frequency band associated with a general blasting sound.

Vehicle position information acquisition unit (mobile object position information acquisition unit) 35 acquires, as illustrated in FIG. 7, position information about vehicle 20a from global positioning system (GPS) 42. Vehicle position information acquisition unit 35 then transmits the position information about vehicle 20a acquired from GPS 42 and the sound signals acquired by microphones 31a to 31c to A/D converter 36.

A/D converter 36 receives the sound signals from vehicle position information acquisition unit 35 and converts the sound signals from an analog format to a digital format. Further, A/D converter 36 operates in synchronization with a signal input from clock 41, and samples respective sound signals at an identical time. A/D converter 36 transmits the A/D-converted sound signals and time information associated with the sounds to blasting direction detector 37. The A/D converter further acquires position information from vehicle position information acquisition unit 35, and transmits the position information to blasting direction detector 37.

Blasting direction detector (position detector, direction detector, position acquisition unit) 37 receives, as illustrated in FIG. 7, the sound signals and time information associated with the sounds from A/D converter 36, and position information about vehicle 20a. When detecting a blasting sound, blasting direction detector 37 detects a direction of blasting position X based on a difference between acquisition times at which the identical blasting sound is acquired by microphones 31a to 31c (a time difference). More specifically, as described above, blasting direction detector 37 obtains a time difference between microphones 31a, 31b, a time difference between microphones 31a, 31c, and a time difference between microphone 31b, 31c. Blasting direction detector 37 further specifies the direction of blasting position X as viewed from vehicle 20a, based on a relationship between the time differences and the angle θ (see FIG. 4).

At this time, blasting direction detector 37 preferably obtains positions of microphones 31a to 31c in order to accurately detect the direction of blasting position X. Therefore, blasting direction detector 37 calculates the positions of microphones 31a to 31c using the position information about vehicle 20a acquired from GPS 42 and an offset value preset in vehicle 20a.

Note that the offset value is a value indicating a relative positional relationship between a reference position of vehicle 20a (for example, virtual center C) and microphones 31a to 31c.

Further, blasting direction detector 37 preferably specifies the direction of vehicle 20a in order to accurately detect the direction of blasting position X. Thus, blasting direction detector 37 detects an advancing direction of vehicle 20a using the position information about vehicle 20a acquired from GPS 42 and time information indicating the time at which the position information is acquired so as to detect the direction of vehicle 20a.

As a result, blasting direction detector 37 can specify the direction of blasting position X of a blasting event generated around vehicle 20a using the direction of vehicle 20a and the angle θ calculated based on the difference between times at which the blasting sound is acquired by microphones 31a to 31c.

Further, blasting direction detector 37 acquires driving information about a driving situation of vehicle 20a from driving information acquisition unit 38. In a case where the driving situation indicates that an event such as engine start occurs, the sound signals acquired by microphones 31a to 31c are input into blasting direction detector 37 with gains being reduced.

Thus, the sound at the time of engine start can be prevented from being erroneously detected as a blasting sound.

Blasting direction detector 37 transmits, as illustrated in FIG. 7, information about blasting position X (information about the direction of blasting position X, information about the time at which a blasting sound is acquired, position information about vehicle 20a, etc.) to communication unit 39.

Driving information acquisition unit 38 acquires driving information about a driving state, such as engine start, of vehicle 20a. Driving information acquisition unit 38 then transmits, as illustrated in FIG. 7, the driving information to blasting direction detector 37.

Communication unit 39 transmits and receives, as illustrated in FIG. 7, various information between vehicle 20a and command center 50. Specifically, communication unit 39 transmits information about blasting position X detected by blasting direction detector 37 to command center 50. Communication unit 39 further transmits the information about blasting position X detected by blasting direction detector 37 to display unit 40.

Note that communication unit 39 can use, for example, a communication function of vehicle-borne PC 21 (see FIG. 3) which is mounted to vehicle 20a and is connected to the internet.

Display unit 40 displays, as illustrated in FIG. 7, the information about blasting position X detected by blasting direction detector 37, and the position information about blasting position X received from command center 50 via communication unit 39.

Note that display unit 40 can use , for example, a liquid crystal panel of vehicle-borne PC 21 (see FIG. 3) mounted to vehicle 20a.

In the present exemplary embodiment, as described above, microphones 31a to 31c are mounted to the positions spaced apart from each other in the vehicle body of vehicle 20a. Vehicle 20a specifies the direction of blasting position X as viewed from vehicle 20a using the difference between times (the time difference) at which the blasting sound is acquired by microphones 31a to 31c.

As a result, the difference between the times at which the blasting sound is acquired by microphones 31a to 31c can be made to be large, and thus the direction of blasting position X can be specified more accurately than in the conventional method.

Clock 41 transmits the time information and a synchronous signal to A/D converter 36.

Specifically, clock 41 transmits the information about the times at which the blasting sound is acquired by microphones 31a to 31c to blasting direction detector 37 via A/D converter 36.

As a result, blasting direction detector 37 can calculate the difference between the times (the time difference) at which the blasting sound is acquired by microphones 31a to 31c.

### Command Center 50

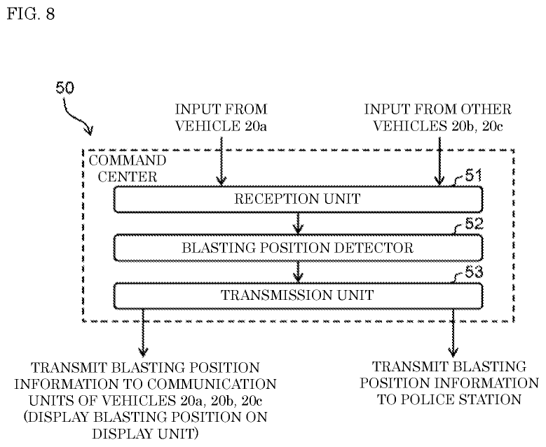

In system for detecting a sound generation position 10 according to the present exemplary embodiment, command center 50 includes, as illustrated in FIG. 8, a communication function for carrying out communication between vehicles 20a to 20c and a police station, and a function for detecting blasting position X.

Command center 50 detects blasting position X using the information about blasting position X received from vehicle 20a and information about blasting position X relating to the identical blasting sounds received from other vehicles 20b, 20c. Command center 50 includes, as illustrated in FIG. 8, reception unit 51, blasting position detector 52, and transmission unit 53.

Reception unit 51 receives the information about blasting position X from communication unit 39 of vehicle 20a. Vehicles 20b, 20c different from vehicle 20a are also mounted with microphones (second sound acquisition units) similarly in vehicle 20a. Vehicles 20b, 20c generate information about blasting position X relating to an identical blasting sound and transmits the information to command center 50. Reception unit 51 receives the information about blasting position X generated by other vehicles 20b, 20c from communication units of vehicles 20b, 20c.

Blasting position detector 52 detects blasting position X based on the information about blasting position X received from vehicle 20a and the information about blasting position X received from other vehicles 20b, 20c.

More specifically, blasting position detector 52 acquires information about the direction of blasting position X as viewed from vehicle 20a and position information about vehicle 20a from communication unit 39 of vehicle 20a via reception unit 51. Blasting position detector 52 further acquires information about blasting position X as viewed from vehicles 20b, 20c and position information about vehicles 20b, 20c from the communication units of vehicles 20b, 20c other than vehicle 20a via reception unit 51.

Blasting position detector 52 detects blasting position X through calculation using the information about the direction of blasting position X as viewed from vehicle 20a, the position information about vehicle 20a, the information about the direction of blasting position X as viewed from the vehicles 20b, 20c and the position information about vehicles 20b, 20c.

Transmission unit 53 transmits the position information about blasting position X detected by blasting position detector 52 to vehicle-borne PCs 21(communication units 39) mounted to vehicles 20a to 20c, respectively. Transmission unit 53 further transmits the position information about blasting position X to the police station.

In the present exemplary embodiment, vehicle 20a specifies the direction of blasting position X as viewed from vehicle 20a using the difference between acquisition times (the time difference) at which the blasting sound is acquired by microphones 31a to 31c. Further, command center 50 specifies blasting position X using the information about the direction of blasting position X and the position information about vehicle 20a received from vehicle 20a, and the information about the direction of blasting position X and the position information about vehicles 20b, 20c received from vehicles 20b, 20c.

Command center 50 transmits the position information about specified blasting position X to vehicles 20a to 20c. Thus, vehicles 20a to 20c can quickly move toward a blasting site.

Command center 50 further transmits the position information about blasting position X also to a police station. For this reason, this police station can specify a police station near blasting position X, and enables another vehicle 20d (see FIG. 1) to move to the blasting site from the specified police station.

### <Flow of Method for Detecting Sound Generation Position>

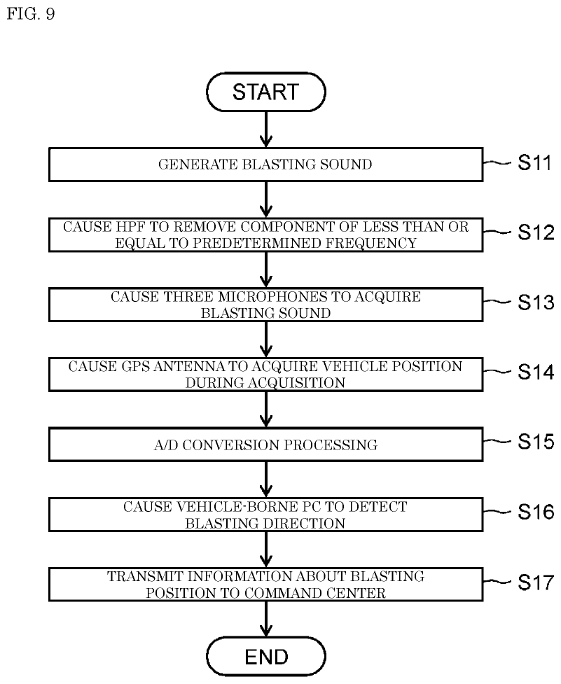

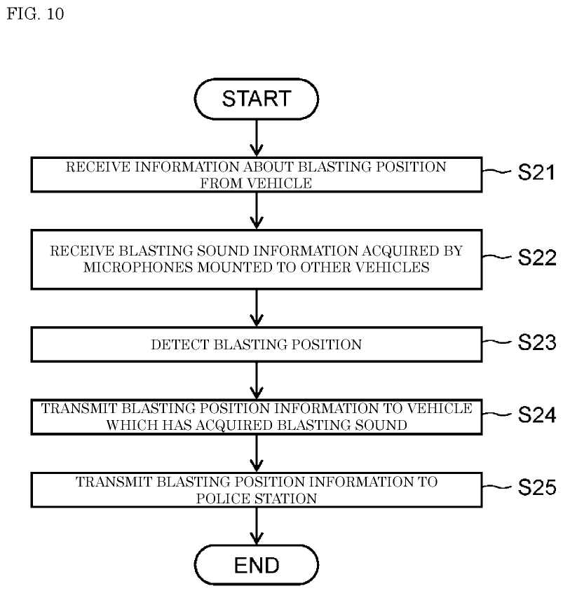

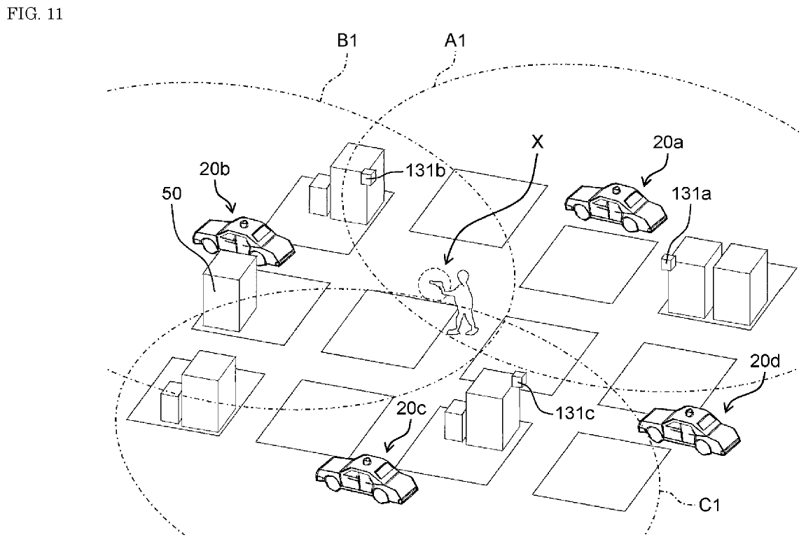

A method for detecting a sound generation position using a system for detecting a sound generation position 10 according to the present exemplary embodiment will be described below with reference to flowcharts in FIG. 9 and FIG. 10.

Herein, a flow of processing in vehicle 20a will be described first.

That is, as illustrated in FIG. 9, generation of a blasting sound in step S11 causes the sound signals including the blasting sound to pass through HPFs 34a to 34c mounted to vehicle 20a in step S12. Therefore, a component of less than or equal to predetermined frequency (for example, less than or equal to 2 kHz) is removed from the sound signals.

In step S13, microphones 31a to 31c acquire the sound signals which includes the blasting sound and from which the component of less than or equal to the predetermined frequency has been removed by HPFs 34a to 34c.

In step S14, vehicle position information acquisition unit 35 acquires position information about vehicle 20a at the time at which the blasting sound is acquired, from GPS 42.

In step S15, A/D converter 36 converts the sound signals, which include the blasting sound and has acquired by microphones 31a to 31c, from an analog format into a digital format.

In step S16, vehicle-borne PC 21 (blasting direction detector 37) detects a direction of blasting position X as viewed from vehicle 20a, based on a difference between the acquisition times (a time difference) at which the sound signals of the blasting sound converted into the digital format are acquired by microphones 31a to 31c and position information (a position, a direction) about vehicle 20a at the acquisition times of the blasting sound.

In step S17, information about blasting position X detected by vehicle-borne PC 21 is transmitted to command center 50 via the communication function (communication unit 39) of vehicle-borne PC 21.

A flow of processing in command center 50 will be described with reference to FIG. 10.

That is, as illustrated in FIG. 10, in step S21, reception unit 51 of command center 50 receives the information about blasting position X as viewed from vehicle 20a from vehicle 20a that has acquired the blasting sound.

In step S22, reception unit 51 receives information about blasting position X of the blasting sound which is acquired by a single or a plurality of microphones mounted to vehicles 20b, 20c other than vehicle 20a and is identical to the blasting sound acquired in vehicle 20a.

In step S23, blasting position detector 52 disposed in command center 50 detects blasting position X through calculation.

That is, blasting position detector 52 acquires the information about blasting position X as viewed from vehicle 20a, from vehicle 20a via reception unit 51. The information about blasting position X includes information about the direction of blasting position X as viewed from vehicle 20a and the position information about vehicle 20a. The information about the direction of blasting position X is acquired, as described above, based on the difference between the acquisition times (the time difference) at which the blasting sound is acquired by microphones 31a to 31c and the position information about vehicle 20a (microphones 31a to 31c). Further, blasting position detector 52 acquires the information about blasting position X from vehicles 20b, 20c other than vehicle 20a via reception unit 51. The information about blasting position X includes the information about the direction of blasting position X as viewed from vehicles 20b, 20c and the position information about vehicles 20b, 20c.

Blasting position detector 52 detects blasting position X through calculation using the information about the direction of blasting position X as viewed from vehicle 20a, the position information about vehicle 20a, and the information about the direction of blasting position X as viewed from the vehicles 20b, 20c and the position information about vehicles 20b, 20c.

In step S24, the information about blasting position X is transmitted to vehicles 20a to 20c which have acquired the blasting sound.

Note that the vehicle which receives the information about blasting position X is not limited to a vehicle which has acquired a blasting sound, and thus may include a vehicle which is near blasting position X but has not acquired the blasting sound because the vehicle is behind a building.

In step S25, the information about blasting position X is transmitted to a police station.

As a result, the police station which has received the information about blasting position X, or a police station which has received a notification from the police station and is near blasting position X enables another vehicle 20d (see FIG. 1) or the like to be rushed to the blasting site.

### Other Exemplary Embodiments

The above has describe one exemplary embodiment of the present disclosure, but the present disclosure is not limited to the above exemplary embodiment, and various changes can be made without departing from the gist of the present disclosure.

### (A)

In the above exemplary embodiment, vehicle 20a detects the direction of blasting position X as viewed from vehicle 20a, based on the difference between the acquisition times at which the blasting sound is acquired by microphones 31a to 31c. Similarly, other vehicles 20b, 20c detect the direction of blasting position X as viewed from vehicles 20b, 20c, based on the difference between the acquisition times at which the identical blasting sound is acquired by microphones. Command center 50 detects blasting position X based on the information about the direction of blasting position X as viewed from vehicles 20b, 20c as well as the information about the direction of blasting position X as viewed from vehicle 20a. However, the present disclosure is not limited to this.

For example, as illustrated in FIG. 11, microphones 131a to 131c are disposed not in vehicles but in a building in a fixed manner. Vehicle 20a detects the direction of blasting position X as viewed from vehicle 20a, based on the difference between the acquisition times at which the blasting sound is acquired by microphones 31a to 31c. Command center 50 may detect blasting position X using a detected result of the blasting sound identical to the blasting sound acquired by at least any one of microphones 131a to 131c as well as the information about the direction of blasting position X as viewed from vehicle 20a.

In this case, position information about fixed microphones 131a to 131c is already known, and thus blasting position X can be detected by using the known position information.

### (B)

The above exemplary embodiment has described an example where, at a stage before microphones (sound acquisitions units) 31a to 31c collect a sound, HPFs (filter units) 34a, 34b, 34c remove a component of less than or equal to predetermined frequency from sound signals. However, the present disclosure is not limited to this.

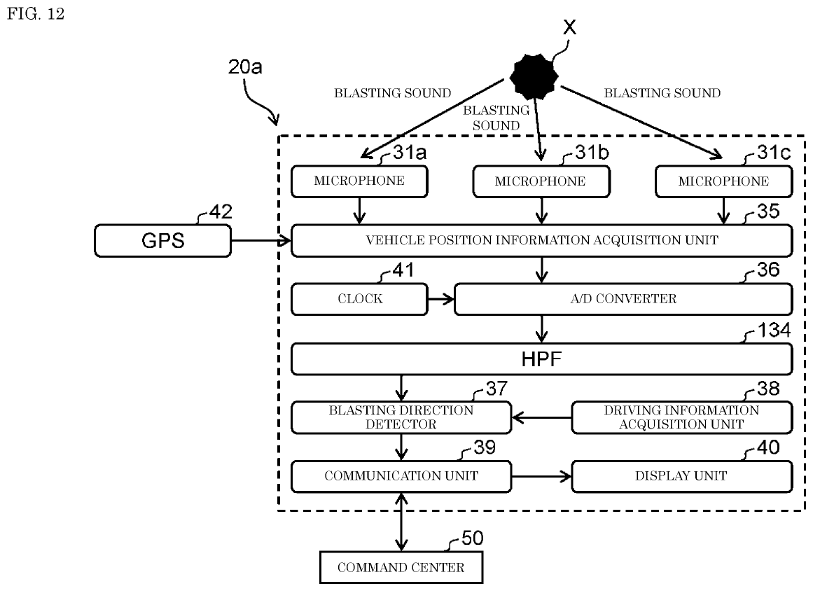

For example, as illustrated in FIG. 12, HPFs 134 as software, which remove components of less than or equal to predetermined frequency from the sound signals acquired by microphones (sound acquisition units) 31a to 31c instead of high pass filters 34a, 34b, 34c, may be used.

### (C)

The above exemplary embodiment has described an example where microphones (sound acquisition units) 31a to 31c are disposed in two places on the front portions of police vehicles 20a, 20b, 20c and in one place on the rear portions. However, the present disclosure is not limited to this.

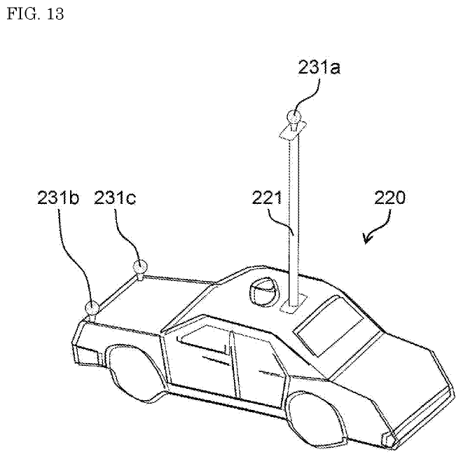

For example, as illustrated in FIG. 13, one microphone 231a may be disposed on an end of pole 221 disposed to protrude upward from a ceiling surface of vehicle 220, and other microphones 231b, 231c may be disposed on a front portion of a vehicle body. That is, at least one of microphones 231a, 231b, 231c mounted to vehicle 220 may be disposed in a height position different from height positions of the other microphones.

As a result, a sound is acquired by using the microphone provided to the high position, and thus a generating position of a sound event can be three-dimensionally detected.

Further, also in a case where three or more microphones are disposed in positions of approximately identical height in the vehicle, like the above exemplary embodiment, the present disclosure is not limited to disposing in the two positions on the front portion and the one position on the rear portion.

For example, the microphones may be disposed in one position on the front portion and on two portions on the rear portion.

Also, in this case, however, it is preferable that the three microphones are disposed so that distances between the microphones are as long as possible.

### (D)

The above exemplary embodiment has described an example where three microphones 31a to 31c are disposed in vehicles 20a, 20b, 20c, respectively, and acquire a blasting sound (a sound of a sound event). However, the present disclosure is not limited to this.

For example, four or more microphones may be disposed in two places on the front portion and two positions on the rear portion of the vehicle, respectively.

Also, in this case, however, it is preferable that the four or more microphones are disposed so that distances between the microphones are as long as possible.

### (E)

The above exemplary embodiment has described an example where when blasting position X is detected, the direction of blasting position X as viewed from vehicle 20a is detected in vehicle 20a, and the information is transmitted to command center 50, and blasting position X is specified in command center 50. However, the present disclosure is not limited to this.

For example, all the direction and the position of blasting position X as viewed from vehicle 20a may be specified in command center 50.

In this case, the vehicles transmit information about the acquisition times of the blasting sound acquired by the mounted microphones and the acquired positions of the vehicles to the command center. As a result, in the command center, the direction and the position of the blasting sound can be specified by using necessary information.

### (F)

The above exemplary embodiment has described an example where blasting position detector 52, which detects a position of a sound (a blasting sound) of a sound event such as blasting, is disposed in command center 50 installed outside vehicles 20a to 20c. However, the present disclosure is not limited to this.

For example, the position detector, which detects a position of a sound (a blasting sound) of a sound event, may be disposed in a vehicle-borne PC mounted to the vehicle.

In this case, position information about the blasting sound acquired by the microphones disposed on other vehicles or a building is communicated with each other, and thus the generating direction or the position of the sound event such as blasting can be detected inside the vehicle. As a result, a police vehicle or the like near blasting position X can rush to the blasting site.

Further, vehicle 20a or command center 50 may specify blasting position X using only information acquired by vehicle 20a without using information from other vehicles 20b, 20c. According to the principle illustrated in FIG. 2, the use of three microphones enables not only the direction but also the position of blasting position X to be specified. Note that the specified position of blasting position X is expressed by parameters based on vehicle 20a such as the direction as viewed from vehicle 20a and a distance from vehicle 20a. In vehicle 20a, the specified position of blasting position X may be expressed by geometric parameters, such as a longitude and a latitude, indicating an absolute position on the earth, using information acquired from GPS 42.

### (G)

The above exemplary embodiment has described an example where when the directions of vehicles 20a to 20c are detected, position information (information about a moving direction) acquired by vehicle position information acquisition unit 35 from GPS 42 is used. However, the present disclosure is not limited to this.

For example, the direction of the mobile object such as a vehicle may be detected by using a detected result from a gyroscope sensor mounted to the mobile object such as a vehicle.

Further, when a Personal Computer (PC) is mounted to a mobile object such as a vehicle, the direction of the mobile object may be detected by using a compass mounted to the PC.

### (H)

The above exemplary embodiment has described an example where the sound of the sound event detected by system for detecting a sound generation position 10 is a blasting sound (a shot). However, the present disclosure is not limited to this.

The system for detecting a sound generation position of the present disclosure can detect also a sound generated by another sound event such as an explosion sound, a breaking sound, or a collision sound generated by an incident, an accident, or terrorism.

The system for detecting a sound generation position of the present disclosure can further detect a sound generated by a sound event such as a flying sound or a propeller noise in consideration of a case where a flying object such as a drone is detected.

Further, the system for detecting a sound generation position of the present disclosure can detect a sound generated by a sound event such as a scream or a cry at a time of occurrence of an incident.

### (I)

The above exemplary embodiment has described an example where microphones (sound acquisition units) 31a to 31c configuring system for detecting a sound generation position 10 are mounted to a police vehicle. However, the present disclosure is not limited to this.

Microphones (sound acquisition units) configuring this system may be disposed in another mobile object such as an ambulance, a taxi, a passenger vehicle, a bus (a school bus), a motorcycle, a truck (a cash transport car), and a transport vehicle (a very important person transport vehicle), a train, or a bicycle besides the police vehicle.

### (J)

In the above exemplary embodiment, for example, an electric power may be supplied to microphones by using an electricity generation function of a vehicle (for example, a generator) or an electricity storage function (for example, a battery).

### (K)

The above exemplary embodiment has described an example where the position information about vehicle 20a is acquired via a GPS (satellite radio wave). However, the present disclosure is not limited to this.

For example, as means for acquiring position information about a mobile object such as a vehicle, besides the GPS (the satellite radio wave), various communication radio waves (a radio wave from a mobile phone base station, a beacon, WiFi, bluetooth (registered tradename), etc.) or the internet (position acquisition from an IP address) may be used.

### INDUSTRIAL APPLICABILITY

The system for detecting a sound generation position of the present disclosure produces an effect such that a sound generation position can be detected accurately, and thus is widely applicable to systems that specify a position of a sound generated by a sound event such as a blasting sound (a shot) or an explosion sound.

What is claimed is:

1. A system for detecting a sound generation position, the system comprising:
three or more first sound acquisition units that acquire a sound of a sound event generated around a first mobile object, the three or more first sound acquisition units disposed in positions spaced apart from each other in the first mobile object, respectively; and
a position detector that detects a direction or a position where the sound event occurs, based on a difference between acquisition times at which the sound is acquired by the three or more first sound acquisition units.

2. The system according to claim 1, further comprising
a second sound acquisition unit that is mounted to another place different from the first mobile object and acquires the sound of the sound event generated around the another place, and
wherein the position detector detects a position where the sound is generated, based on sound information about the sound received from each of the three or more first sound acquisition units and the second sound acquisition unit.

3. The system according to claim 2, further comprising
a second mobile object different from the first mobile object, and
wherein the second sound acquisition unit is disposed in the second mobile object.

4. The system according to claim 1, further comprising a time information acquisition unit that acquires time information about a time at which the sound of the sound event is acquired.

5. The system according to claim 1, further comprising:
a mobile object position information acquisition unit that acquires position information indicating a position of the first mobile object; and
a position acquisition unit that acquires positions of the three or more first sound acquisition units using the position of the first mobile object acquired by the mobile object position information acquisition unit and offset values indicating a relative positional relationship between a reference position of the first mobile object and positions of the three or more first sound acquisition units.

6. The system according to claim 1, further comprising a direction detector that detects a direction of the first mobile object at a time of detecting the sound event.

7. The system according to claim 6, further comprising:
a mobile object position information acquisition unit that acquires position information indicating a position of the first mobile object,
wherein the direction detector detects a direction of the first mobile object based on an advancing direction of the first mobile object detected by using the position information acquired by the mobile object position information acquisition unit.

8. The system according to claim 1,
wherein the first mobile object has a front portion, a rear portion, and both right and left ends in a widthwise direction on the front portion, and
wherein the three or more first sound acquisition units are disposed at both the right and left ends of the first mobile object and on the rear portion of the first mobile object.

9. The system according to claim 1, wherein at least one of the three or more first sound acquisition units is disposed in a height position different from a height position of at least one of remaining sound acquisition units in the first mobile object.

10. The system according to claim 1, further comprising a filter unit that removes a component of less than or equal to predetermined frequency from the sound acquired by the three or more first sound acquisition units.

11. The system according to claim 1,
wherein the position detector is disposed outside the first mobile object,
the system further comprising a communication unit that receives the sound acquired by the three or more first sound acquisition units and transmits the sound to the position detector.

12. The system according to claim 11, wherein the communication unit transmits information about the position where the sound event occurs detected by the position detector to the first mobile object.

13. The system according to claim 11, further comprising a display unit that displays information about the position where the sound event occurs received via the communication unit, the display unit being mounted to the first mobile object.

14. The system according to claim 11, wherein the communication unit transmits information about the position where the sound event occurs to a police station.

15. The system according to claim 1, further comprising:
a driving information acquisition unit that acquires driving information about the first mobile object,
wherein the position detector reduces an input level of a sound received from the three or more first sound acquisition units, based on the driving information.

16. The system according to claim 1, wherein the position detector is disposed in the first mobile object.

17. The system according to claim 1, wherein the sound of the sound event includes at least one of a blasting sound, an explosion sound, a breaking sound, a collision sound, a flying sound, a propeller noise, a scream, and a cry.

18. The system according to claim 1, wherein the first mobile object includes at least one of a police vehicle, an ambulance, a taxi, a passenger vehicle, a school bus, a motorcycle, a truck, and a transport vehicle.

19. A method for detecting a sound generation position, the method comprising:
causing three or more sound acquisition units to acquire a sound of a sound event generated around a mobile object, the three or more sound acquisition units being disposed in positions spaced apart from each other in the mobile object; and
detecting a direction or a position where the sound event occurs, based on a difference between acquisition times at which the sound is acquired by the three or more sound acquisition units.
